(19) United States
(12) Patent Application Publication
(10) Pub. No.: US 2021/0009037 A1
(43) Pub. Date: Jan. 14, 2021

(54) VEHICLE SIGHTING DEVICE, AND METHOD OF SETTING ANGLE OF VIEW OF IMAGING SECTION OF VEHICLE SIGHTING DEVICE

(71) Applicant: KABUSHIKI KAISHA TOKAI-RIKA-DENKI-SEISAKUSHO, Aichi (JP)

(72) Inventors: Masanori KOSUGI, Aichi (JP); Takashi NAGAO, Aichi (JP); Tetsuya EGAWA, Aichi (JP)

(21) Appl. No.: 16/969,915

(22) PCT Filed: Feb. 8, 2019
(86) PCT No.: PCT/JP2019/004620

§ 371 Date: Aug. 13, 2020

(30) Foreign Application Priority Data
Feb. 20, 2018 (JP) 2018-027776

(51) Int. Cl. B60R 1/00; H04N 7/18; H04N 5/262; H04N 5/232; B60R 11/04; B60R 1/04; B60R 1/12

(52) U.S. Cl. CPC B60R 1/00; H04N 7/183; H04N 5/2628; B60R 2011/004; B60R 11/04; B60R 1/04; B60R 1/12; H04N 5/23296

(57) ABSTRACT

When a relationship between a distance from a rear camera to a target subject, and a ratio of a size of the target subject displayed on a monitor with respect to a size of the target subject reflected in a half-mirror, is determined while fixing an angle of view of the rear camera to a predetermined value, the angle of view of the rear camera is set such that a size of the target subject at an infinite distance in the relationship becomes a size that is 0.33 times to 0.5 times a size of the target subject that is reflected in the half-mirror.

### TECHNICAL FIELD

The present invention relates to a vehicle sighting device by which the periphery of a vehicle is viewed due to images of the periphery of the vehicle being captured and the captured images being displayed, and to a method of setting an angle of view of an imaging section of a vehicle sighting device.

### BACKGROUND ART

There is known a technique of installing a vehicle sighting device, which displays captured images of the periphery of a vehicle and by which the periphery of the vehicle is viewed, instead of an optical mirror in a vehicle.

For example, International Application Publication No. 2016/042733 proposes an electronic mirror device that switches between displaying the image of a rear camera that is provided at a vehicle rear portion and captures images of the rear side of the vehicle, and the image of a mirror camera that is set in the vicinity of the mounted position of the rearview mirror and captures images of the vehicle rear side. Concretely, switching of the display is carried out without giving the vehicle occupant a sense of incongruity, by switching display in a case in which an image of a noted object that the rear camera has captured and an image of the noted object that the mirror camera has captured have become the same.

Further, Japanese Patent Application Laid-Open (JP-A) No. 2017-58600 proposes an image display system in which a half-mirror is provided at the display surface of a display device that displays captured images, and it is possible to switch between a rearward visual field that is reflected in the half-mirror and a rearward visual field that is displayed on the display device. Concretely, there is proposed changing to an operation mode that is suited to the state of the vehicle, by switching the display in accordance with the traveling state.

### SUMMARY OF INVENTION

### Technical Problem

If there is structure that switches the image that is displayed as in International Application Publication No. 2016/042733, it is possible to switch between the image of the rear camera and the image of the mirror camera without giving the vehicle occupant an uncomfortable feeling. However, in JP-A No. 2017-58600, when switching between the rearward visual field that is reflected in a half-mirror and the rearward visual field that is shown by display of a captured image, there is the concern that the vehicle occupant will be given a sense of incongruity due to the sizes of a target subject that is projected being different. Further, also in a structure that does not have an optical mirror such as a half-mirror or the like, it is desirable to display a captured image that is similar to an image reflected in an optical mirror.

The present invention was made in view of the above-described circumstances, and an object thereof is to provide a vehicle sighting device, and a method of setting an angle of view of an imaging section of a vehicle sighting device, that can display a captured image that is similar to an image reflected in an optical mirror.

### Solution to Problem

In order to achieve the above-described object, a first aspect comprises: a display portion that is provided within a vehicle cabin and displays a captured image of a vehicle rear side; and an imaging section that is disposed at a vehicle rear portion, that captures the captured image of the vehicle rear side that is to be displayed on the display portion, and that is set to an angle of view such that a size of a target subject at an infinite distance in a case of displaying the captured image at the display portion becomes a size that is greater than or equal to 0.33 times a size of the target subject that is reflected in an optical mirror, assuming that the optical mirror is disposed at a position of the display portion.

In accordance with the first aspect, the display portion is provided within a vehicle cabin, and a captured image of the vehicle rear side is displayed thereon. Due thereto, due to the captured image being displayed at the display portion, the rear side can be seen by using the display portion.

The imaging section is disposed at a vehicle rear portion, and captures a captured image of the vehicle rear side that is to be displayed on the display portion. Further, the imaging section is set to an angle of view that is such that the size of a target subject at an infinite distance when displaying the captured image at the display portion becomes a size that is greater than or equal to 0.33 times the size of the target subject that is reflected in an optical mirror in a case of assuming that the optical mirror is disposed at the position of the display portion. Due thereto, a captured image that is similar to an image that is reflected in an optical mirror can be displayed.

Note that the imaging section may be set to an angle of view that is such that the size of the target subject at an infinite distance becomes 0.33 times to 0.5 times the size of the target subject that is reflected in the optical mirror.

On the other hand, a second aspect is a method of setting an angle of view of an imaging section of a vehicle sighting device that has a display portion that is provided within a vehicle cabin and displays a captured image of a vehicle rear side, he imaging section being disposed at a vehicle rear portion and capturing, by imaging the vehicle rear side, the captured image that is to be displayed on the display portion, the method comprising: setting an angle of view of the imaging section based on a ratio of a size, at an infinite distance, of a target subject that is reflected in an optical mirror in a case of assuming that the optical mirror is disposed at a position of the display portion, and a size of the target subject that is displayed at the display portion at an infinite distance.

In accordance with the second aspect, at the time of setting the angle of view of the imaging section of a vehicle sighting device that has a display portion that is provided within a vehicle cabin and displays a captured image of a vehicle rear side, and the imaging section that is disposed at a vehicle rear portion and that, by imaging the vehicle rear side, captures the captured image that is to be displayed on the display portion, the angle of view of the imaging section is set based on a ratio of the size, at an infinite distance, of the target subject that is reflected in an optical mirror in a case of assuming that the optical mirror is disposed at the position of the display portion, and the size of the target subject that is displayed at the display portion at an infinite distance. Due thereto, a captured image that is similar to an image that is reflected in an optical mirror can be displayed.

In this case, when a relationship between a distance from the imaging section to the target subject, and a ratio of a size of the target subject displayed at the display portion with respect to a size of the target subject reflected in the optical mirror, is determined while fixing the angle of view of the imaging section to a predetermined value, setting the angle of view of the imaging section may include setting the predetermined value such that a size of the target subject at an infinite distance in the relationship becomes a size that is greater than or equal to 0.33 times the size of the target subject that is reflected in the optical mirror.

Or, when a relationship between a distance from the imaging section to the target subject, and a ratio of a size of the target subject displayed at the display portion with respect to a size of the target subject reflected in the optical mirror, is determined while fixing the angle of view of the imaging section to a predetermined value, setting the angle of view of the imaging section may include setting the predetermined value such that a size of the target subject at an infinite distance in the relationship becomes a size that is 0.33 times to 0.5 times the target subject that is reflected in the optical mirror. Advantageous Effects of Invention

As described above, in accordance with the present invention, there is the effect of being able to provide a vehicle sighting device, and a method of setting an angle of view of an imaging section of a vehicle sighting device, that can display a captured image that is similar to an image reflected in an optical mirror.

### BRIEF DESCRIPTION OF DRAWINGS

FIG. 1A is a front view in which main portions within a cabin of a vehicle are seen from a vehicle rear side.

FIG. 1B is a plan view that is seen from above and shows a vehicle at which a vehicle sighting device is provided.

FIG. 2 is a block drawing showing the schematic structure of the vehicle sighting device relating to the present embodiment.

FIG. 3 is a schematic top view of the vehicle.

FIG. 4 is a drawing showing results of comparing the size of an object, which can be imaged at a time of receding from the vehicle with the angle of view of a rear camera being fixed, with the size that is reflected in a half-mirror.

FIG. 5 is a flowchart showing an example of the flow of processings at the time of displaying an image on a monitor, which processings are carried out by a control device of the vehicle sighting device relating to the present embodiment.

### DESCRIPTION OF EMBODIMENTS

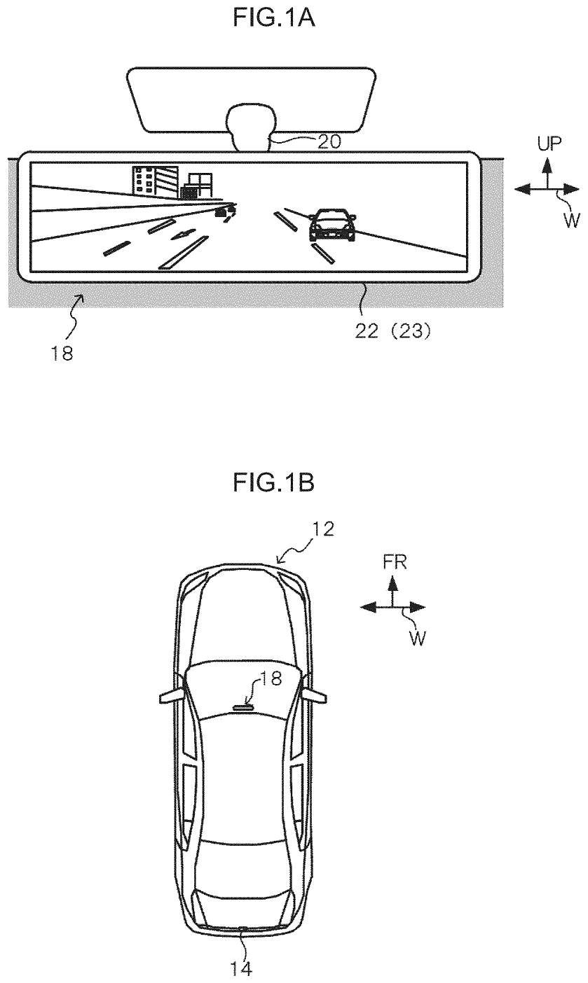

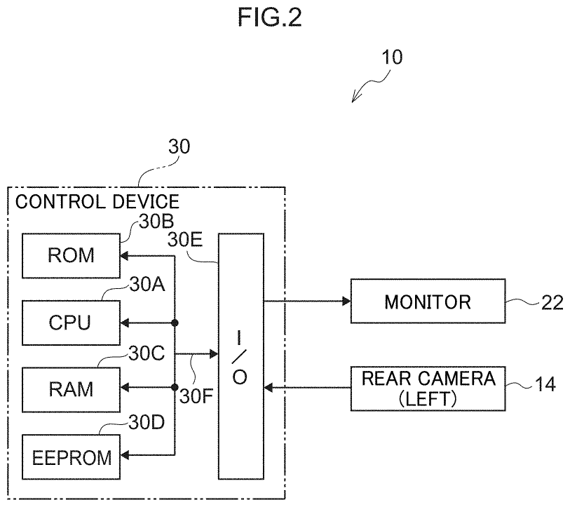

An embodiment of the present invention is described in detail hereinafter with reference to the drawings. FIG. 1A is a front view in which main portions of a cabin interior of a vehicle 12 are seen from a vehicle rear side, and FIG. 1B is a plan view that is seen from above and shows the vehicle 12 at which a viewing device 10 for a vehicle is provided. Further, FIG. 2 is a block drawing showing the schematic structure of the viewing device 10 for a vehicle relating to the present embodiment. Note that, in the respective drawings, arrow FR indicates the vehicle front side, arrow W indicates the vehicle transverse direction, and arrow UP indicates the vehicle upper side.

A rear camera 14 that serves as an imaging section is provided at the viewing device 10 for a vehicle. The rear camera 14 is disposed at the vehicle rear portion such as the trunk or like for example, and can capture images of the rear side of the vehicle 12 at a predetermined angle of view (imaging region).

Further, an inner mirror 18 is provided within the cabin of the vehicle 12. At the inner mirror 18, the base portion of a bracket 20 is mounted to the vehicle front side and the vehicle transverse direction central portion of the ceiling surface within the cabin. A monitor 22, which serves as a display portion and is shaped as an elongated rectangle, is provided at the bracket 20. The monitor 22 is mounted to the lower end portion of the bracket 20 with the length direction of the monitor 22 being the vehicle transverse direction and the display surface of the monitor 22 being directed toward the vehicle rear side. Due thereto, the monitor 22 is disposed in a vicinity of the upper portion of the front windshield glass that is at the vehicle front side, and the display surface that displays images can be seen by vehicle occupants who are within the cabin.

A half-mirror (wide mirror) 23 is provided at the display surface of the monitor 22. When the monitor 22 is not displaying, the rearward visual field through the cabin interior as well as the rear windshield glass and the door glasses is shown in the half-mirror 23.

On the other hand, a control device 30 is provided at the viewing device 10 for a vehicle. The rear camera 14 and the monitor 22 are connected to the control device 30. A microcomputer, at which a CPU 30A, a ROM 30B, a RAM 30C, a non-volatile storage medium (e.g., an EEPROM) 30D and an I/O (input/output interface) 30E are respectively connected to a bus 30F, is included in the control device 30. Various programs, such as a viewing/displaying control program for a vehicle and the like, are stored in the ROM 30B. The control device 30 displays an image, which assists viewing by the vehicle occupant, on the monitor 22 due to the CPU 30A reading-out and executing programs that are stored in the ROM 30B.

The control device 30 carries out processing that displays a captured image, which is captured by the rear camera 14, on the monitor 22 as an image for display. For example, the control device 30 generates the image for display by cutting-out a region of a predetermined range from the captured image that is captured by the rear camera 14. Further, because the monitor 22 is provided further toward the vehicle front side than the driver's seat, the control device 30 carries out, on the captured image, mirror image converting processing that left-right reverses the image that is to be displayed on the monitor 22, and displays the image. Note that, hereinafter, there are cases in which the description omits the mirror image converting processing. Further, the entire captured image may be used as the image for display, without cutting-out a region of a predetermined range from the captured image.

By the way, at the viewing device 10 for a vehicle relating to the present embodiment, the half-mirror 23 is provided at the display surface of the monitor 22, and it is possible to switch between the rearward visual field reflected by the half-mirror 23 and the rearward visual field displayed by the monitor 22. Therefore, the angle of view of the rear camera 14 must be determined appropriately in order to make it such that there is no sense of incongruity in the images that are seen at the time of switching between the rearward visual field reflected in the half-mirror 23 and the rearward visual field displayed by the monitor 22. Thus, the method of setting the angle of view of the rear camera 14 is described hereinafter.

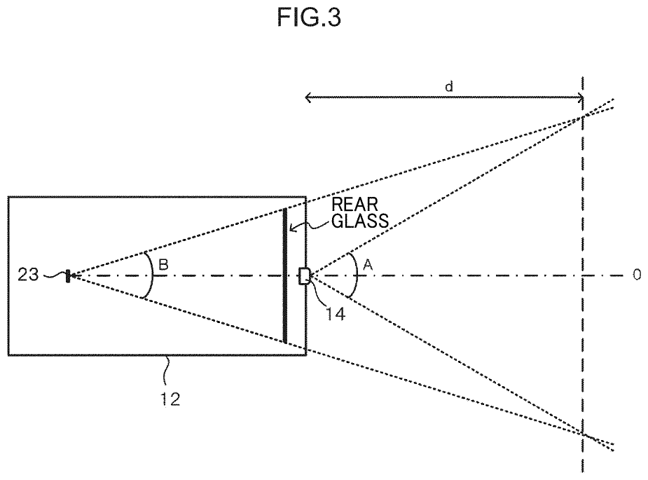

A schematic top view of the vehicle is shown in FIG. 3. As shown in FIG. 3, because only the portion that can be seen through the rear glass at the vehicle rear side can be seen from the half-mirror 23, the rear can be viewed at angle B. On the other hand, the rear camera 14 can capture an image at an arbitrary angle of view A, and can output the captured image to the monitor 22. Namely, although angle A is arbitrary, angle B is a fixed value that is determined by the structure of the vehicle.

In a case in which the captured image cannot be displayed due to problems with the monitor 22 or the like, display is switched to the half-mirror 23. Therefore, the size of the mirror that a person sees is physically the same size, whether it be an optical mirror or an electronic mirror. Accordingly, it is desirable for the same image to be reflected at the time of switching between the rearward visual field that is reflected in the half-mirror 23 and the rearward visual field that is displayed on the monitor 22.

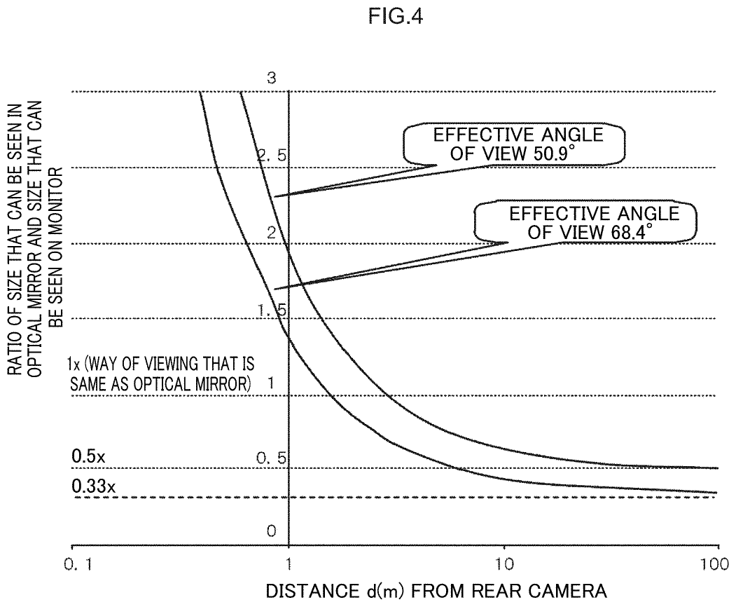

The method of setting the angle of view is described in detail hereinafter by using a vehicle of a given structure as an example. FIG. 4 is a drawing showing the results of comparing the size of an object, which can be imaged at the time of receding from the vehicle with the angle of view of the rear camera 14 being fixed, with the size that is reflected in the half-mirror 23.

Because the size that is reflected in the half-mirror 23 is the standard, a magnification of 1× remains as 1× regardless of the distance from the vehicle. In contrast, in close proximity to the vehicle, a target subject in a case of imaging by the rear camera 14 is projected larger than the image reflected in the half-mirror 23, because the object is nearer than the half-mirror 23. On the other hand, for a target subject that is far-off, for example, if the target subject is further away than a position (distance d in FIG. 3) where the angle of view of the half-mirror 23 (angle B) and the angle of view of the rear camera 14 (angle A) intersect, the range that is projected is wider in the rear camera 14 than at the half-mirror 23. Therefore, at the monitor 22, the further away the target subject, the smaller the target subject is projected, but the size approaches a fixed value that is 1/n (where n is 1 or more) of the size of the object that is reflected in an optical mirror (the half-mirror 23). The results that are graphed in FIG. 4 arise because there is a difference in the positions of the half-mirror 23 and the rear camera 14. At a position that is sufficiently far from the rear camera 14 (e.g., 100 m), the difference in the positions of the half-mirror 23 and the rear camera 14 is small to the extent of being able to be ignored, and the sizes of an object that is reflected in the half-mirror 23 and that which is captured by the rear camera 14 are constant at 1/n. In other words, the ratio of the size of a target subject that is reflected in the half-mirror at an infinite distance and the size of the target subject that is displayed on the monitor 22 at an infinite distance converges to the fixed value of 1/n. Thus, in the present embodiment, the angle of view of the rear camera 14 is set based on the ratio of the size of a target subject that is reflected in the half-mirror at an infinite distance and the size of the target subject that is displayed on the monitor 22 at an infinite distance.

Here, by setting the angle of view such that 1/n is made to approach 1, for objects that are sufficiently far-off, there is no sense of incongruity in the images that are seen when switching between the rearward visual field reflected in the half-mirror 23 and the rearward visual field displayed by the monitor 22. However, for objects that are in close proximity to the vehicle, the more that the fixed value 1/n approaches 1, the larger the image at the time of switching to the rearward visual field displayed on the monitor 22, and a sense of incongruity at the time of switching arises. For example, in a case in which the effective angle of view in FIG. 4 is 68.4°, the size is approximately 1.4x when the distance from the rear camera 14 is 1 m, and, in a case in which the effective angle of view is 50.9°, the size is approximately 2× when the distance from the rear camera 14 is 1 m. As the angle of view approaches the angle of view at which the magnification becomes 1× at 1 m, the size of the target subject that is displayed on the monitor 22 becomes larger than the size of the target subject that is reflected in the half-mirror 23, and a sense of incongruity is given.

On the other hand, the rule (No. 46) of the agreement relating to indirect vision in vehicle regulations prescribes that “in the case of a Class 1 (inner mirror), the average value of the magnification coefficient should not fall below 0.33 times”. Due thereto, at an electronic mirror as well, it is desirable that the angle of view of the rear camera 14 be set such that the size of a target subject that is displayed on the monitor 22 with respect to the size of the target subject that is reflected in the half-mirror 23 becomes greater than or equal to 0.33 times.

Thus, in order for there not to be a sense of incongruity in the images that are seen at the time of switching between the rearward visual field reflected in the half-mirror 23 and the rearward visual field displayed by the monitor 22, an angle of view that is such that the above-described 1/n becomes greater than or equal to 0.33 times is selected. Further, in the present embodiment, from predetermined subjective evaluation, in close proximity to the vehicle (e.g., 1 m), an extent of 2× is permitted, and 1/n being 0.5 times is employed as the upper limit. Namely, in the example of FIG. 4, an angle of view of 50.9° to 68.4° is selected. Due thereto, because it can be thought that the road and the like at the rear are sufficiently far, even in a case of switching between the rearward visual field that is reflected in the half-mirror 23 and the rearward visual field that is displayed on the monitor 22, the way of viewing is limited to a difference that is within 0.33 times to 0.5 times, and a sense of incongruity in the images that can be seen at the time of switching is suppressed, provided that the figures are similar.

Namely, in the present embodiment, when the relationship between the distance from the rear camera 14 to the target subject, and the ratio of the size of the target subject displayed in the monitor 22 with respect to the size of the target subject reflected in the half-mirror 23, is determined while fixing the angle of view of the rear camera 14 to a predetermined value, the angle of view of the rear camera 14 is set such that the size of the target subject at an infinite distance in that relationship becomes a size that is 0.33 times to 0.5 times the size of the target subject reflected in the half-mirror 23. Due thereto, an angle of view, which is suited to enabling suppression of the sense of incongruity at the time of switching between the rearward visual field reflected in the half-mirror 23 and the rearward visual field displayed on the monitor 22, can be set.

Note that setting the angle of view of the rear camera 14 may be setting the angle of view of an optical system that the rear camera 14 has, or may be setting the angle of view at the time of cutting-out a region from the captured image of the rear camera 14.

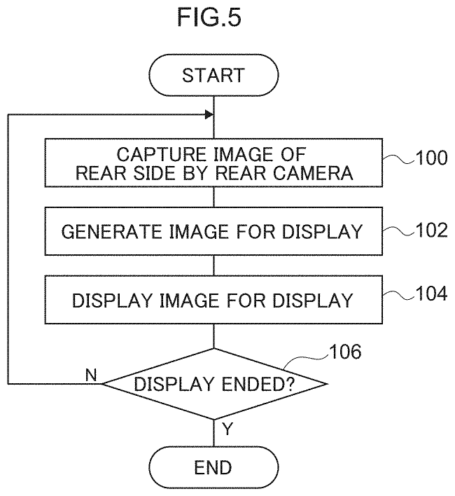

The concrete processings that are carried out at the control device 30 of the viewing device 10 for a vehicle relating to the present embodiment are described next. FIG. 5 is a flowchart showing an example of the flow of processings at the time of displaying an image on the monitor 22, which processings are carried out at the control device 30 of the viewing device 10 for a vehicle relating to the present embodiment. Note that the processings of FIG. 5 are carried out due to the viewing/display control program for a vehicle being executed, and start in a case in which an unillustrated ignition switch (IG) is turned on. Or, a switch that switches between displaying or not displaying on the monitor 22 may be provided, and the processings may start in a case in which displaying is instructed. In this case, due to the switch being turned on, image display onto the monitor 22 is started. Due to the switch being turned off, the image display onto the monitor 22 is ended, and the monitor 22 functions as a rearview mirror (the half-mirror 23).

In step 100, due to the CPU 30A carrying out imaging by the rear camera 14, the captured image is read-in, and the CPU 30A moves on to step 102.

In step 102, the CPU 30A generates a display image, and moves on to step 104. Namely, the CPU 30A carries out processings such as extracting of a predetermined region, and the like, on the captured image of the rear camera 14, and carries out mirror image converting processing that reverses the image left and right, and generates an image for display.

In step 104, the CPU 30A displays the generated image for display on the monitor 22, and moves on to step 106.

In step 106, the CPU 30A judges whether or not display onto the monitor 22 is finished. This judgment is a judgement as to whether or not the ignition switch has been turned off, or as to whether or not an instruction for non-display has been given at the switch of the monitor 22. If this judgment is negative, the routine returns to step 100 and the above-described processings are repeated. If this judgment is affirmative, the series of display processings is ended.

Here, in a case in which display onto the monitor 22 is ended by the switch or the like, the rearward visual field is projected by the half-mirror 23. In the present embodiment, an angle of view, which is such that the ratio (1/n) of the size that can be seen in an optical mirror and the size that can be seen on the monitor 22 is 0.33 times to 0.5 times at an infinite distance, is set as described above. Due thereto, the sense of incongruity at the time of switching between the rearward visual field reflected in the half-mirror and the rearward visual field displayed on the monitor 22 can be suppressed.

Further, the angle of view is set such that the size of the target subject at an infinite distance becomes a size that is greater than or equal to 0.33 times the size of the target subject that is reflected in the half-mirror 23. Therefore, the requirement of the rule that is established for an optical mirror can be satisfied.

Note that the present embodiment describes a form in which only the captured image of the rear camera 14 is displayed on the monitor 22. However, the present invention is not limited to this. For example, a vehicle cabin image may be combined with the captured image of the rear camera 14, and this image may be displayed in the same way as the image that is reflected in the half-mirror 23. In this case, a captured image (a video image) of a camera that images the vehicle cabin interior may be used as the vehicle cabin image. Or, a captured image in which the vehicle cabin interior is imaged in advance at the time when the vehicle is manufactured at or is shipped out from the factory or the like, or a captured image that is captured before traveling of the vehicle starts, may be used. Or, the vehicle cabin image is not limited to an image captured by a camera, and an illustration that depicts the vehicle cabin interior, or the like, may be used therefor.

Further, the above-described embodiment describes an example in which the half-mirror 23 is provided at the display surface of the monitor 22, but there may be a form in which the half-mirror 23 is omitted. Even in a form in which the half-mirror 23 is omitted, by setting the angle of view of the rear camera 14 as in the above-described embodiment, a captured image, which is similar to an image reflected in an optical mirror, can be displayed on the monitor 22.

Further, the processings that are carried out by the control device 30 in the above-described embodiment are described as software processings, but are not limited to this. For example, these processings may be processings that are carried out by hardware, or may be processings that combine both hardware and software.

Further, the processings that are carried out by the control device 30 in the above-described embodiment may be stored as a program on a storage medium and distributed.

Moreover, the present invention is not limited to the above, and can of course be implemented by being modified in various ways other than the above within a scope that does not depart from the gist thereof.

The disclosure of Japanese Patent Application No. 2018-027776 filed on Feb. 20, 2018 is, in its entirety, incorporated by reference into the present specification.

1. A vehicle sighting device, comprising:
a display that is provided within a vehicle cabin and displays a captured image of a vehicle rear side; and
an imaging section that is disposed at a vehicle rear portion, that captures the captured image of the vehicle rear side that is to be displayed on the display, and that is set to an angle of view such that a size of a target subject at an infinite distance in a case of displaying the captured image at the display becomes a size that is greater than or equal to 0.33 times a size of the target subject that is reflected in an optical mirror, assuming that the optical mirror is disposed at a position of the display.

2. The vehicle sighting device of claim 1, wherein the imaging section is set to an angle of view such that the size of the target subject at an infinite distance becomes 0.33 times to 0.5 times the size of the target subject that is reflected in the optical mirror.

3. A method of setting an angle of view of an imaging section of a vehicle sighting device that has a display that is provided within a vehicle cabin and displays a captured image of a vehicle rear side, the imaging section being disposed at a vehicle rear portion and capturing, by imaging the vehicle rear side, the captured image that is to be displayed on the display, the method comprising:
setting an angle of view of the imaging section based on a ratio of a size, at an infinite distance, of a target subject that is reflected in an optical mirror in a case of assuming that the optical mirror is disposed at a position of the display, and a size of the target subject that is displayed at the display at an infinite distance.

4. The method of setting an angle of view of an imaging section of a vehicle sighting device of claim 3, wherein, in a case in which a relationship between a distance from the imaging section to the target subject, and a ratio of a size of the target subject displayed at the display with respect to a size of the target subject reflected in the optical mirror, is determined while fixing the angle of view of the imaging section to a predetermined value, setting the angle of view of the imaging section includes setting the predetermined value such that a size of the target subject at infinite distance in the relationship becomes a size that is greater than or equal to 0.33 times the size of the target subject that is reflected in the optical mirror.

5. The method of setting an angle of view of an imaging section of a vehicle sighting device of claim 3, wherein in a case in which a relationship between a distance from the imaging section to the target subject, and a ratio of a size of the target subject displayed at the display with respect to a size of the target subject reflected in the optical mirror, is determined while fixing the angle of view of the imaging section to a predetermined value, the setting of the angle of view of the imaging section sets the predetermined value such that a size of the target subject at an infinite distance in the relationship becomes a size that is 0.33 times to 0.5 times the size of the target subject that is reflected in the optical mirror.
